(19) United States
(12) Patent Application Publication
(10) Pub. No.: US 2026/0121785 A1
(43) Pub. Date: Apr. 30, 2026

(54) PN AND MIC FIELDS IN TRIGGER FRAMES

(71) Applicants: Laurent Cariou, Milizac (FR); Po-Kai Huang, San Jose, CA (US); Danny Alexander, Neve Efraim Monoson (IL); Danny Ben-Ari, Tsur Natan (IL)

(72) Inventors: Laurent Cariou, Milizac (FR); Po-Kai Huang, San Jose, CA (US); Danny Alexander, Neve Efraim Monoson (IL); Danny Ben-Ari, Tsur Natan (IL)

(21) Appl. No.: 19/433,233

(22) Filed: Dec. 26, 2025

Related U.S. Application Data
(60) Provisional application No. 63/743,172, filed on Jan. 8, 2025.

(51) Int. Cl. H04L 1/00

(52) U.S. Cl. CPC H04L 1/0006; H04L 1/0061

(57) ABSTRACT

Methods, apparatuses, and computer readable media for PN and MIC fields in trigger frames, where a station is configured to decode, a trigger frame, the trigger frame comprising user information (info) fields, where a first user info field of the user info fields comprises a first AID12 field and a first IFCS field, the first AID12 field indicating a value that indicates the first user info field indicates a first portion of an IFCS, and the first IFCS field indicating bits 0 to 23 of the IFCS, and wherein a second user info field of the user info fields comprises a second AID12 field and a second IFCS field, the second AID12 field indicating the value that indicates the second user info field indicates a second portion of the IFCS, and the second IFCS field indicating bits 24 to 31 of the IFCS, and wherein the IFCS is a CRC.

### PRIORITY CLAIM

This application claims the benefit of priority under 35 USC 119(e) to U.S. Provisional Patent Application Ser. No. 63/743,172, filed Jan. 8, 2025 [AG42928-Z] which is incorporated herein by reference in its entirety.

### TECHNICAL FIELD

Embodiments relate to signaling packet numbers and trigger control Message Integrity Codes (MIC) in trigger frames, in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with newer protocols and with legacy protocols on multiple bands and channels.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a basic service set (BSS) in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates multi-link devices (MLD) s, in accordance with some embodiments;

FIG. 9 illustrates user info fields for an intermediate FCS (iFCS) field, in accordance with some embodiments.

FIG. 10 illustrates user info fields for a packet number (PN) field, in accordance with some embodiments.

FIG. 11 illustrates user info fields for a message integrity code (MIC) field, in accordance with some embodiments.

FIG. 12 illustrates a method for PN and MIC fields in trigger frames, in accordance with some embodiments.

FIG. 13 illustrates a method for PN and MIC fields in trigger frames, in accordance with some embodiments.

FIG. 14 illustrates a CIP capabilities element, in accordance with some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

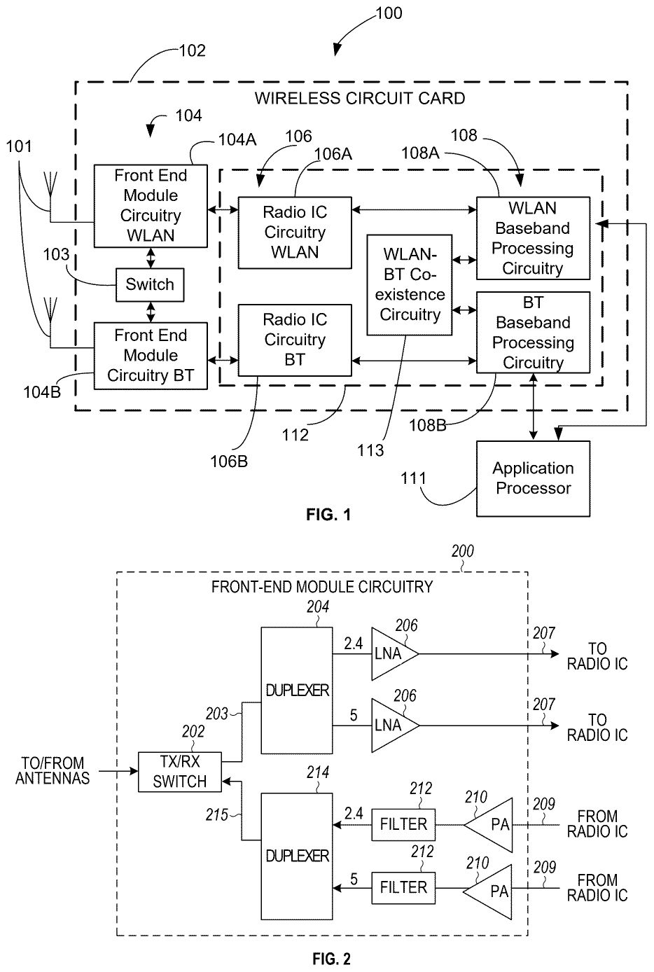

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE P802.11-REVmf™/D1.1, September 2025, IEEE P802.11-REVmf™/D1.1, September 2025, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. In some embodiments, the radio architecture 100 may include impulse radio (IR) and/or ultra-wideband (UWB) IEEE 802.15.4ab.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about nine hundred MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), UWB with 500 MHz and 1 GHz. In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHz signal paths and may utilize the same FEM circuitry 200 as the one used for WLAN communications.

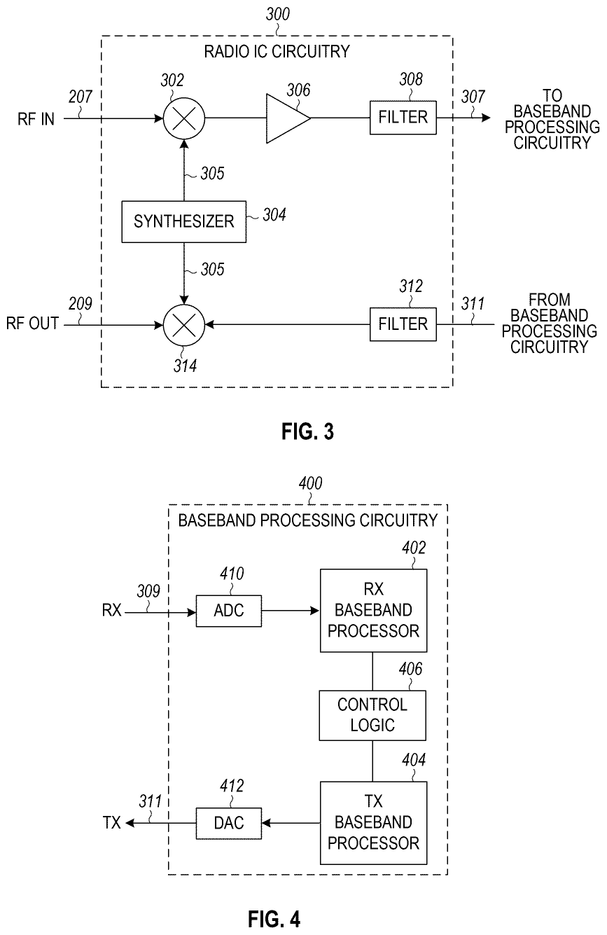

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP 402) for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

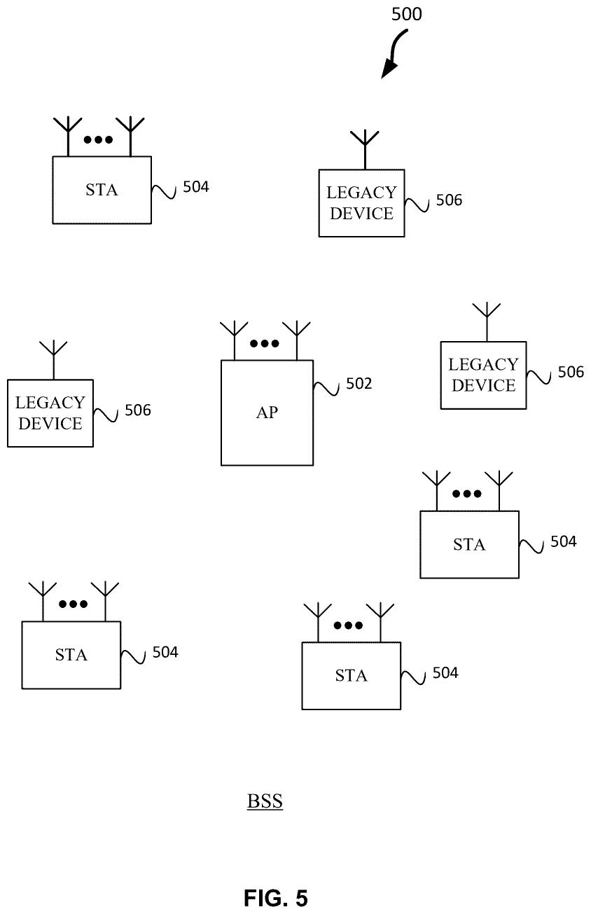

FIG. 5 illustrates a basic service set (BSS 500) in accordance with some embodiments. The BSS 500 may be part of wide area local area network (WLAN). The BSS 500 includes an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT), WiFi 8 IEEE 802.11 ultra-high throughput (UHT), high efficiency (HE) IEEE 802.11ax, IEEE 802.11bn next generation or ultra-high reliability (UHR), and/or another IEEE 802.11 wireless communication standard. In some embodiments, the STAs 504 and/or AP 502 are configured to operate in accordance with IEEE P802.11be, and/or IEEE P802.11-REVme™, both of which are hereby included by reference in their entirety, and to operate in accordance with one or more functions described herein. In some embodiments, one or more the legacy devices 506, STAs 504, and/or the AP 502 may be configured to operate in accordance with one or more Wi-Fi Alliance (WFA) communication standards.

The AP 502 may use other communications protocols as well as the IEEE 802.11 protocol. The terms here may be termed differently in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax/uht, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE, EHT, UHT frames may be configurable to have the same bandwidth as a channel. The HE, EHT, UHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, downlink (DL) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE, EHT, UHT, UHT, or UHR frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax/be embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE, EHT, UHR control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/UHR communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP) (non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-14.

In example embodiments, the STAs 504 and/or the AP 502 are configured to perform the methods and operations/functions described herein in conjunction with FIGS. 1-14. In example embodiments, an apparatus of the STA 504 and/or an apparatus of the AP 502 are configured to perform the methods and functions described herein in conjunction with FIGS. 1-14. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of, or affiliated with, an AP MLD 808, e.g., AP1 830, AP2 832, or AP3 834. The STAs 504 may be part of, or affiliated with, a non-AP MLD 809, which may be termed a ML non-AP logical entity. The BSS may be part of an extended service set (ESS), which may include multiple APs, access to the internet, and may include one or more management devices.

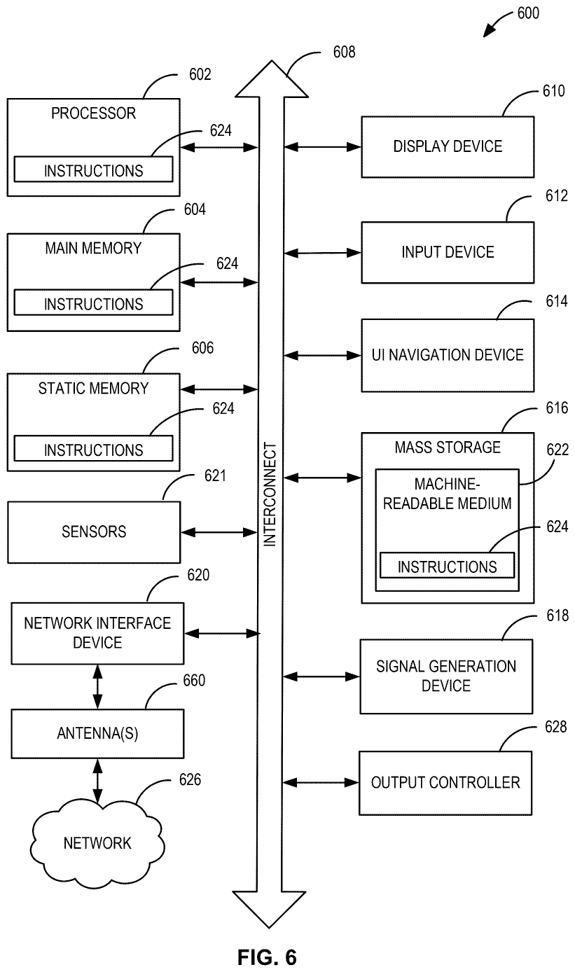

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

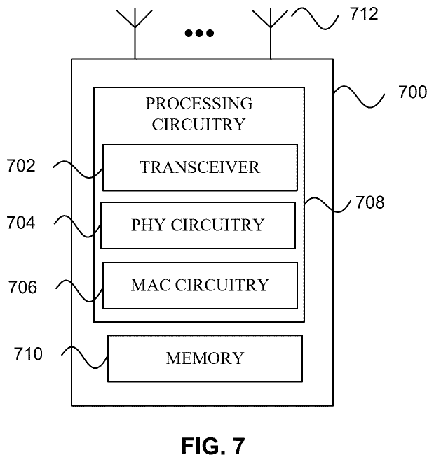

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mm Wave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

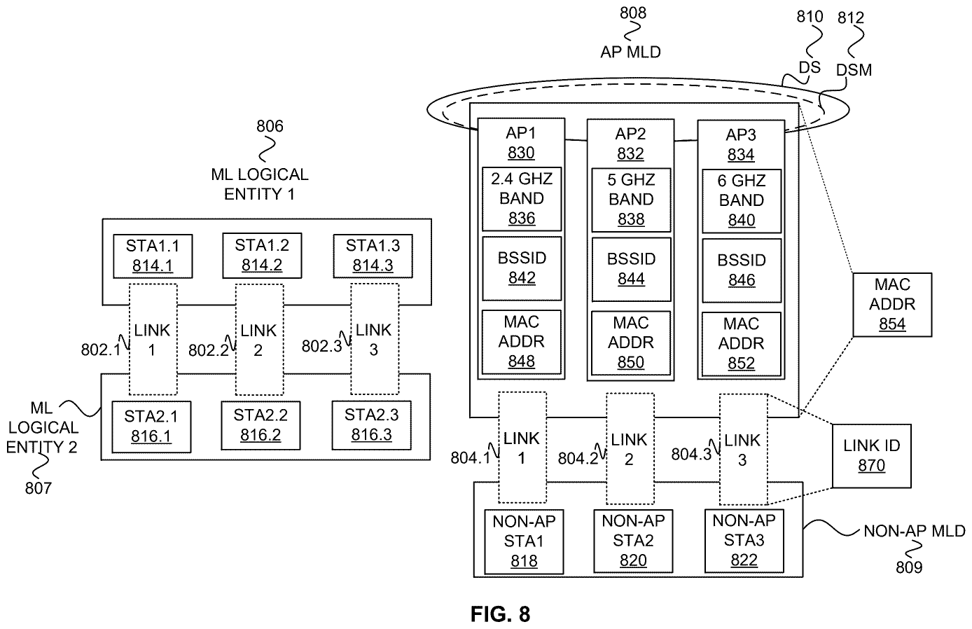

FIG. 8 illustrates multi-link devices (MLD) s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHz band, 6 GHz band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM 812) indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC ADDR 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains one or more STAs 814.1, 814.2, 814.3, 816.1, 816.2, and 816.3. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

New features of ultra-high reliability (UHR) require additional fields to implement the new features related to trigger frames. However, many of the frames have no room for additional fields and adding new fields to frames such as trigger frame may make it difficult for UHR to work with legacy communications standards.

A technical challenge is how to include the fields. In some embodiments, a new intermediate FCS field is used in trigger frames for different UHR features, such as Dynamic Power Save, Dynamic Subband Operation, and so forth, and PN and MIC fields in trigger frames for Secured control Frames feature.

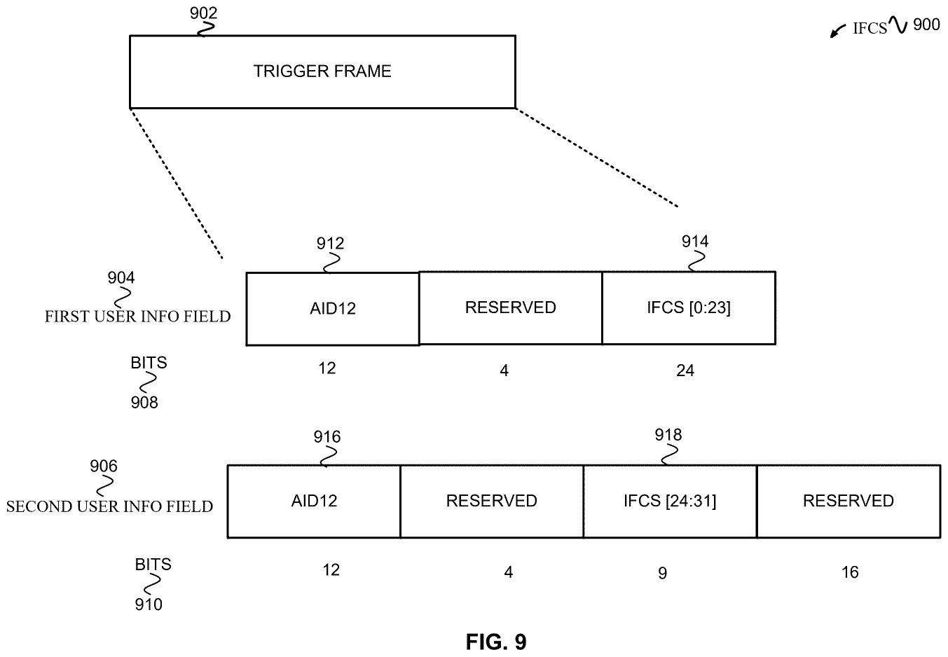

FIG. 9 illustrates user info fields for an intermediate FCS (iFCS) 900 field, in accordance with some embodiments. The intermediate frame check sequence (FCS) (IFCS) is a CRC that is calculated for the trigger frame 902, in accordance with a method indicated in the UHR communications standard. The FCS field contains a 32-bit CRC. The FCS field value is calculated over all of the fields of the MAC header and the Frame Body field. These are referred to as the calculation fields. A receiver shall discard an MPDU that fails the FCS check without further processing.

The iFCS 900 field comprises the first user info field 904 and the second user info field 906. The first user info field 904 and the second user info field 906 are contiguous but do not need to be the first and second user info fields of the trigger frame 902. There can be other user info fields after the iFCS 900 user info fields.

The iFCS 900 field is 4 bytes are 32 bits. The AID12 912 and AID12 916 have a special value to indicate they are the iFCS 900 field. The IFCS 914 field includes the first three bytes of the iFCS 900 field and the second user info filed 906 includes IFCS 918 which includes the last byte of the iFCS 900 field. The two User Info fields, first user info field 904, and second user info field 906, that contain the iFCS are present in a Trigger frame 902 that is an Immediate Coordinated Feedback (ICF) trigger frame 902. After the first user info field 904, and second user info field 906, there may be other user info fields for STAs that do not require an IFCS, which is before the padding field and FCS field of the trigger frame 902.

Define a Special User Info field for intermediate FCS field, that we call iFCS User Info field. This iFCS User Info field is identified by using a reserved special value in the AID12 field (first field of the User Info field)—for instance 2043. The remaining 28 bits in the User Info field are repurposed to include part of the iFCS field. The Intermediate FCS field to include is 4 bytes so can not fit into a single iFCS User Info field. We propose to split the iFCS field into 2 sub-parts included in 2 consecutive iFCS User Info fields (these 2 consecutive iFCS User Info fields are identified by setting AID field to the special AID value for iFCS.

The first iFCS User Info field includes the first part of the 4 Bytes iFCS field in a field included right after the AID12 field in the User Info field. The second iFCS User Info field includes the second part of the 4 Bytes iFCS field in a field included right after the AID12 field in the User Info field. To simplify implementation, we propose to split the iFCS field per Bytes, and include the 3 first Bytes of the iFCS in the first iFCS User Info field and the last Byte of the iFCS in the second iFCS User Info field. Alternatively, we can include the first 28 bits of the iFCS in the first iFCS User Info field and the remaining 4 bits in the second iFCS User Info field. The bits 908, 910, indicate a number of bits of the fields.

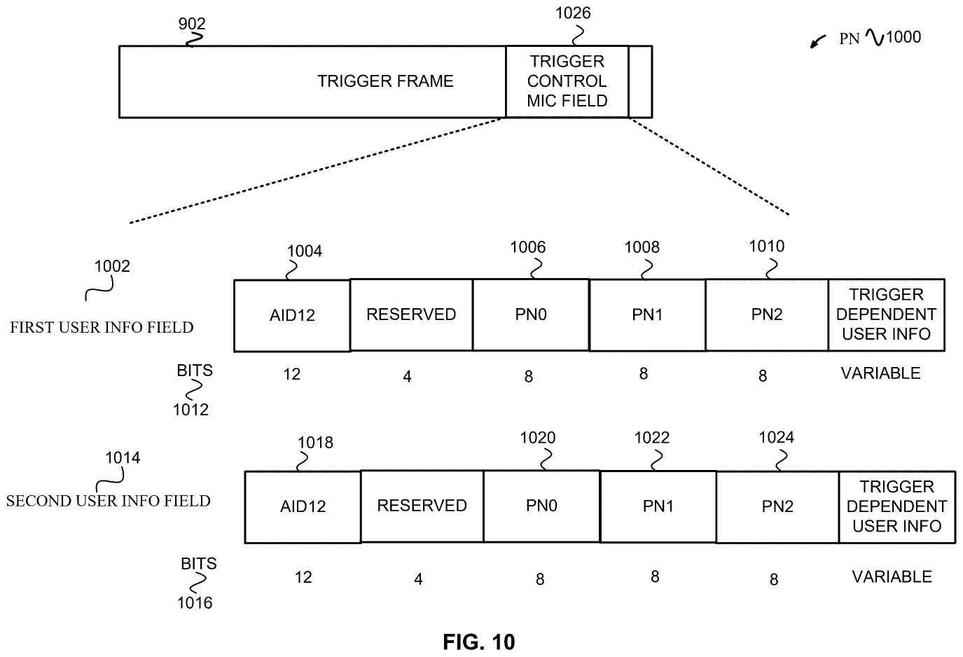

FIG. 10 illustrates user info fields for a packet number (PN) 1000 field, in accordance with some embodiments. The trigger control Message Integrity Code (MIC) field 1026 contains User Info fields such as eight. The Trigger Control MIC field 1026 provides integrity protection for the Trigger frame 902. The Trigger Control MIC field 1026 is present if the Protected Control subfield is equal to 1, otherwise, the Trigger Control MIC field is not present.

The first and the second User Info fields of the Trigger Control MIC field contain the PN corresponding to the integrity key indicated by the Key ID field. The AID12 1004 subfield and AID12 1018 subfield are equal to a number (such as 2042 or another number such as 2009) to indicate that they indicate the PN 1000 field.

The format of the first user info field 1002 (first user info field of the trigger control MIC field) and the second user info field 1014 (second user info field of the trigger control MIC field) indicate the PN 1000 field. The first user info field 1002 indicates the first three bytes of the PN 1000 field as PN0 1006, PN1 1008, and PN2 1010. The second user info field 1014 indicates the last three bytes of the PN 1000 field as PN0 1020, PN1 1022, and PN2 1024. The bits 1012, 1016 indicate a number of bits in the fields. In accordance with some embodiments, the PN is a 48-bit (6-byte) counter used as a cryptographic nonce/IV in the encryption and integrity protection mechanisms such as WPA2 (CCMP) and WPA3.

Define a Special User Info field for PN, called PN User Info field. The PN User Info field is identified by using a reserved special value in the AID12 field (first field of the User Info field)—for instance 2042. The PN field to include is 6 bytes so cannot fit into a single PN User Info field. We propose to split the PN field into 2 sub-parts included in 2 consecutive PN User Info fields (these 2 consecutive PN User Info fields are identified by setting AID12 field to the special AID value for PN. The first PN User Info field includes the first part of the 6 Bytes PN field in a field included right after the AID12 field in the User Info field, The second PN User Info field includes the second part of the 6 Bytes PN field in a field included right after the AID12 field in the User Info field. To simplify implementation, we propose to split the PN field per Bytes, and include the 3 first Bytes of the PN in the first PN User Info field and the last 3 Bytes of the PN in the second PN User Info field. Alternatively, we can include the first 28 bits of the PN in the first PN User Info field and the remaining 20 bits in the second PN User Info field.

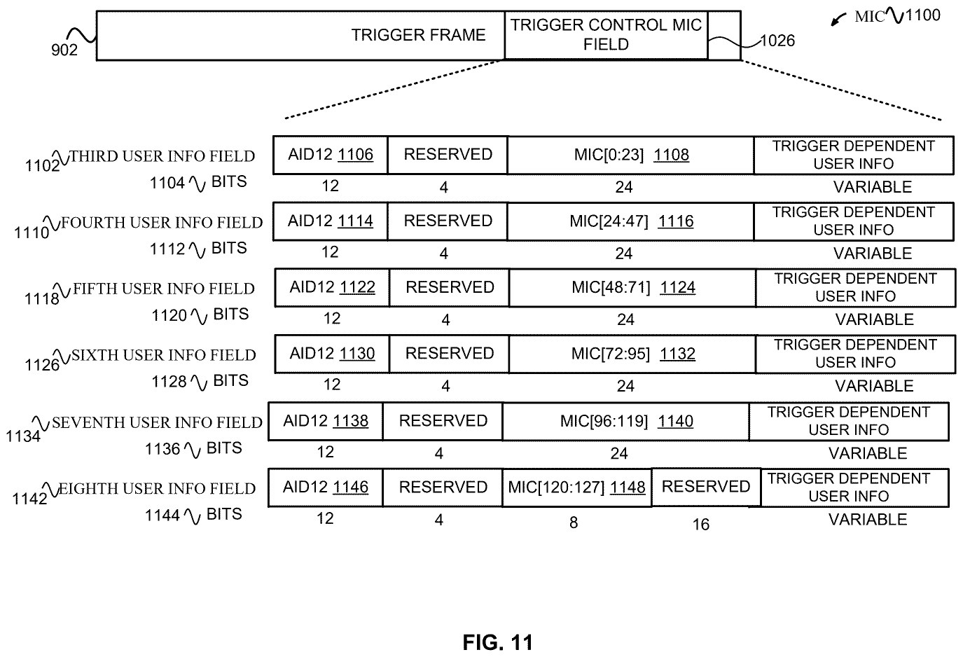

FIG. 11 illustrates user info fields for a message integrity code (MIC) 1100 field, in accordance with some embodiments. In some examples, the MIC 1100 field is the third through eighth user info field of the trigger control MIC field. The bits 1104, 1112, 1120, 1128, 1136, and 1144 indicate the number of bits in the fields.

In some embodiments, the AID12 1106, AID12 1114, AID12 1122, AID12 1130, AID12 1138, and AID12 1146 are all set to a same number to indicate the MIC 1100 field. The third user info field comprises bits 0 to 23 of the MIC value, the fourth user info field comprises bits 24 to 47 of the MIC value, and fifth user info field comprises bits 48 to 71 of the MIC. The sixth user info field comprises bits 72 to 95 of the MIC value, the seventh user info field comprises bits 96 to 119 of the MIC value, and eighth user info field comprises bits 120 to 127 of the MIC value.

The third user info field (third user info field of the trigger control MIC field) 1102 has the AID12 1106 set to a number to indicate that the third user info field is a first user info field of the MIC 1100 field. The MIC[0:23] 1108 includes the first 24 bits (1-3th bytes) of the MIC 1100 field.

The fourth user info field (fourth user info field of the trigger control MIC field) 1110 has the AID12 1114 set to a number to indicate that the fourth user info field is a second user info field of the MIC 1100 field. The MIC[24:47] 1116 includes the second 24 bits (4-6th bytes) of the MIC 1100 field.

The fifth user info field (fifth user info field of the trigger control MIC field) 1118 has the AID12 1122 set to a number to indicate that the fifth user info field is a third user info field of the MIC 1100 field. The MIC[48:71] 1124 includes the third 24 bits (7-9th bytes) of the MIC 1100 field.

The sixth user info field (sixth user info field of the trigger control MIC field) 1126 has the AID12 1130 set to a number to indicate that the sixth user info field is a fourth user info field of the MIC 1100 field. The MIC[72:95] 1132 includes the fourth 24 bits (10-12th bytes) of the MIC 1100 field.

The seventh user info field (seventh user info field of the trigger control MIC field) 1134 has the AID12 1138 set to a number to indicate that the seventh user info field is a fifth user info field of the MIC 1100 field. The MIC[96:119] 1140 includes the fifth 24 bits (13-15th bytes) of the MIC 1100 field.

The eighth user info field (eighth user info field of the trigger control MIC field) 1142 has the AID12 1146 set to a number to indicate that the eighth user info field is a sixth user info field of the MIC 1100 field. The MIC[120:127] 1148 includes 8 bits (16th byte) of the MIC 1100 field.

Define a Special User Info field for MIC, called MIC User Info field. The MIC User Info field is identified by using a reserved special value in the AID12 field (first field of the User Info field)—for instance 2041. The MIC field to include is 16 bytes so can not fit into a single MIC User Info field. We propose to split the MIC field into 6 sub-parts included in 6 consecutive MIC User Info fields (these 6 consecutive MIC User Info fields are identified by setting AID12 field to the special AID value for MIC. The first MIC User Info field includes the first part of the 16 Bytes MIC field in a field included right after the AID12 field in the User Info field, The second MIC User Info field includes the second part of the 16 Bytes MIC field in a field included right after the AID12 field in the User Info field, and so on. To simplify implementation, we propose to split the MIC field per Bytes, and include the 3 first Bytes (Bytes 0, 1 and 2) of the MIC in the first MIC User Info field, Bytes 3,4,5 of the MIC in the second MIC User Info field, and so on. Alternatively, we can split the MIC to fill completely the MIC User Info field and include 28 bits per MIC User info field. In that case, we only need 5 consecutive MIC User Info fields instead of 6. Alternatively, we can define a single special User Info field for both PN and MIC. Similarly, we can also define a single special User Info field for PN, MIC and iFCS. In some embodiments, the MIC calculation is based on the fields of the trigger frame before the PN User Info field and does not include the PN User Info field in the calculation.

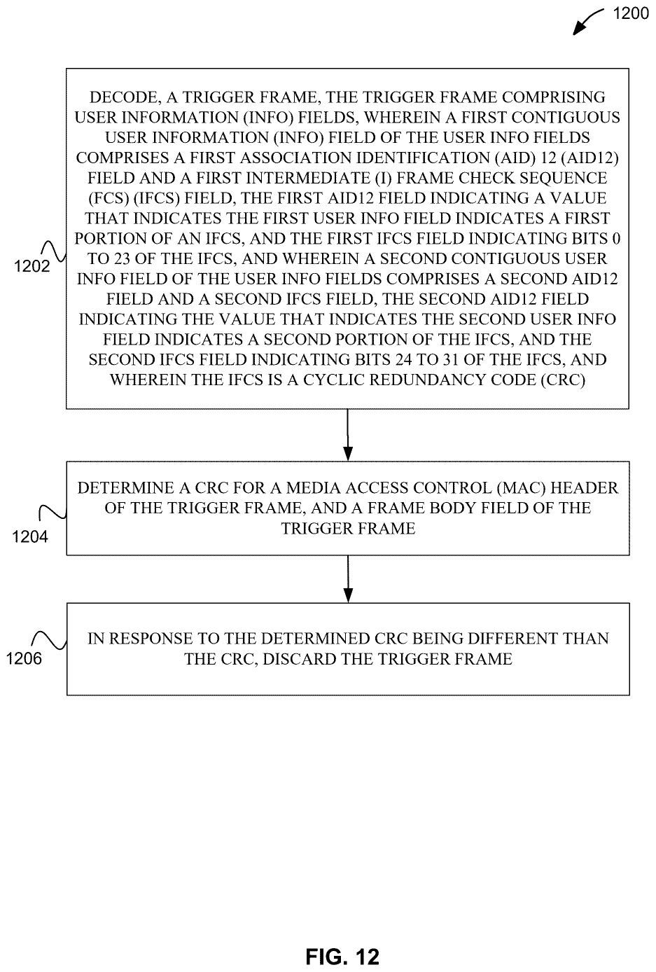

FIG. 12 illustrates a method 1200 for PN and MIC fields in trigger frames, in accordance with some embodiments. The method 1200 begins at operation 1202 with decoding, a trigger frame, the trigger frame comprising user information (info) fields, wherein a first contiguous user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second contiguous user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is a cyclic redundancy code (CRC).

For example, the STA 504 can decode a trigger frame with the iFCS 900 as described in conjunction with FIG. 9. The method 1200 continues at operation 1204 with determining a CRC for a media access control (MAC) header of the trigger frame, and a frame body field of the trigger frame. For example, a STA 504 can determine the CRC for the trigger frame 902. The method 1200 continues at operation 1206 with in response to the determined CRC being different than the CRC, discarding the trigger frame. For example, the STA 504 can discard the trigger frame 902 if the received CRC does not match the determined CRC.

The method 1200 may be performed by an apparatus of an STA. The method 1200 may be performed by an MLD or a STA affiliated with an MLD. The method 1200 may include one or more additional instructions. The method 1200 may be performed in a different order. One or more of the operations of method 1200 may be optional.

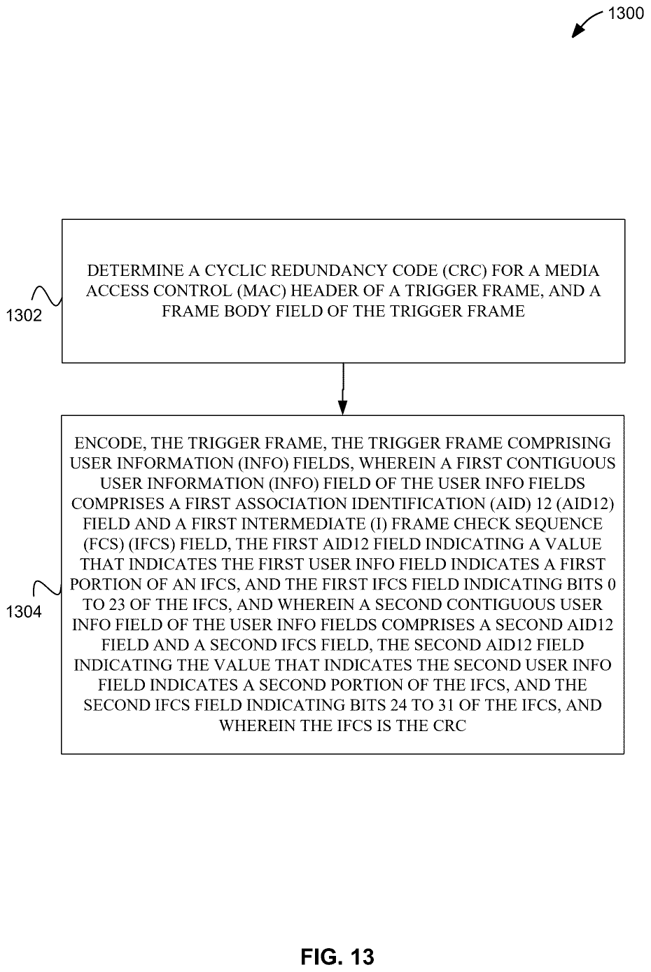

FIG. 13 illustrates a method 1300 for PN and MIC fields in trigger frames, in accordance with some embodiments. The method 1300 begins at operation 1302 with determining a cyclic redundancy code (CRC) for a media access control (MAC) header of a trigger frame, and a frame body field of the trigger frame. For example, an AP 502 can determine the CRC for the trigger frame 902.

The method 1300 continues at operation 1304 with encoding, the trigger frame, the trigger frame comprising user information (info) fields, wherein a first contiguous user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second contiguous user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is the CRC. For example, an AP 502 can encode the trigger frame 902 with the iFCS 900 as described in conjunction with FIG. 9. The AID12 value can be 2010 or another number.

The method 1300 may be performed by an apparatus of an STA. The method 1300 may be performed by an MLD or a STA affiliated with an MLD. The method 1300 may include one or more additional instructions. The method 1300 may be performed in a different order. One or more of the operations of method 1300 may be optional.

Frame protection for trigger frames, block acknowledgement requests (BAR) frames, and block acknowledgement (BA) frames could resolve the security problem of Trigger frames, BAR frames, and BA frames. With a MIC in the Trigger frame, BAR frame, and BA frame, which is used to verify the authenticity of the frames creates additional hardware requirement on the receiver and as a result. A technical problem is how to ensure the receiver has time to verify the frames with the MIC. The technical problem is addressed, in accordance with some embodiments, by adding padding to provide more time for the receiver to verify the MIC. Providing a fixed duration of padding may not be adequate as some receivers may take longer to process the Trigger fames, BA frames, or BAR frames with the MICs. In some embodiments, the technical challenge is addressed with a signaling that indicates a padding delay. Another technical problem is permitting receivers that are not UHR stations the time to process the frames with the MIC. Additionally, another technical problem is how to adopt the padding to different encodings such as BCC or Low-Density Parity-Check (LDPC). In some embodiments, the technical problems are addressed with a general element that indicates a padding delay, which can be used by UHR stations and other STAs. Additionally, the technical challenge is addressed with rules of padding for BCC and LDPC encoding frames. Under the proposals, legacy stations and UHR stations can have the capability to do control frame protection and detailed rules of BCC and LDPC encoding are defined.

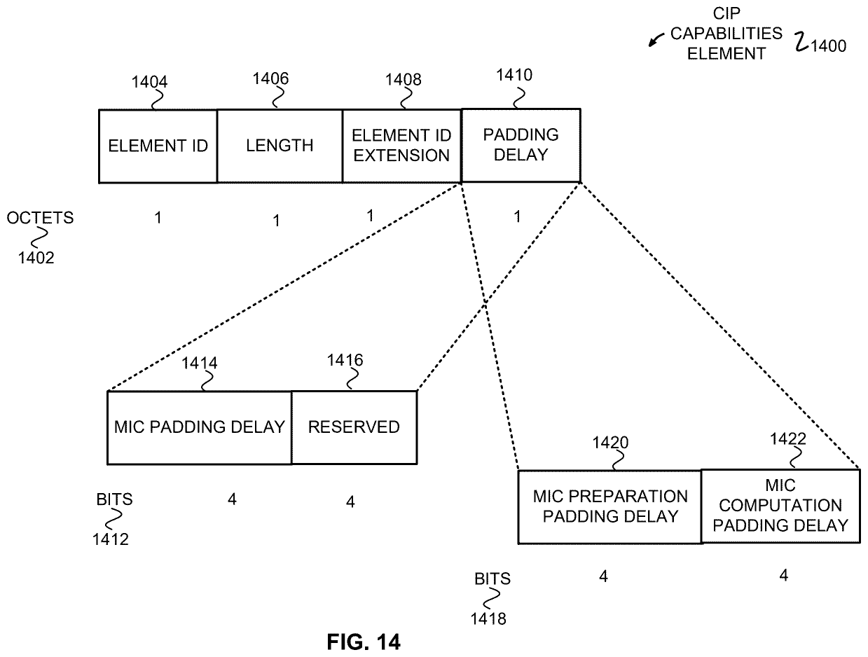

FIG. 14 illustrates a CIP capabilities element 1400, in accordance with some examples. The control integrity protocol (CIP) capabilities element 1400 includes an element identification (ID) 1404 field, a length 1406 field, an element ID extension 1408 field, and a padding delay 1410 field. The element ID 1404 field, length 1406 field, and element ID extension 1408 field are as defined in the communications standard. The octets 1402 indicate the number of octets each field has. In some embodiments, the padding delay 1410 field comprises a MIC preparation padding delay 1420 field and MIC computation padding delay 1422 field with bits 1418.

The MIC preparation padding delay 1420 field indicates the minimum padding duration of the PPDU soliciting protected control frame from the STA that sends the CIP Capability element as defined below. The MIC Preparation Padding Delay 1420 field indicates padding delay equal to 4 us times the value of the field. Table 1 provides an example of the values.

The MIC Computation Padding Delay 1422 field indicates the minimum padding duration of the protected control frame received by the STA that sends the CIP capability element as defined below. The MIC Computation Padding Delay 1422 field indicates padding delay equal to 4 us times the value of the field. Table 1 provides an example of the values. In some embodiments, the MIC preparation padding delay 1420 field and the MIC Computation Padding Delay 1422 are combined into the MIC padding delay 1414 field as described herein.

The padding delay 1410 field includes a MIC padding delay 1414 field and a reserved 1416 field. In some examples, the reserved 1416 field is a MIC computation padding delay field with 4 bits. The bits 1412 indicate the number of bits in the fields. The MIC padding delay 1414 field can be termed a MIC preparation padding delay. In some examples, Table 1 is applicable to a MIC computation padding delay field, which can be the reserved 1416 field, in accordance with some examples.

TABLE 1
Values of the MIC Padding Delay Field corresponding
to their respective duration

| | | |
|---|---|---|
| 0 | 0 | μs |
| 1 | 4 | μs |
| 2 | 8 | μs |
| 3 | 12 | μs |
| 4 | 16 | μs |
| 5 | 20 | μs |
| 6 | 24 | μs |
| 7 | 28 | μs |
| 8 | 32 | μs |

| | |
|---|---|
| 9-15 | Reserved |

The MIC padding delay 1414 field contains the MIC padding delay used with CIP. The MIC padding delay 1414 field indicates the minimum padding duration that is needed within a PPDU that solicits a protected control frame from the STA transmitting the CIP Capabilities element or the minimum padding duration that is needed within a protected control frame that is addressed to the STA transmitting the CIP Capabilities element. Table 1 indicates durations indicated by values of the MIC padding delay 1414 field.

In some examples, there is a MIC Preparation Padding Delay field and a MIC preparation padding delay field comprised in the padding delay 1410 field. The MIC Preparation Padding Delay field indicates the minimum padding duration of the PPDU soliciting protected control frame from the STA that sends the CIP Capability element as defined below. The MIC Preparation Padding Delay field indicates padding delay equal to 4 us times the value of the field. An example of the indication is in Table 1, Encoding of the MIC Preparation Padding Delay field. The MIC Computation Padding Delay field indicates the minimum padding duration of the protected control frame received by the STA that sends the CIP capability element as defined below. The MIC Computation Padding Delay field indicates padding delay equal to 4 us times the value of the field. An example of the indication is in Table 1, encoding of the MIC Computation Padding Delay field.

The MIC preparation indicates the minimum padding duration that is to be used within a PPDU that solicits a protected control frame from the STA transmitting the CIP Capabilities element and the MIC computation padding delay field indicates the minimum padding duration that is needed within a protected control frame that is addressed to the STA transmitting the CIP Capabilities element.

The MIC Preparation Padding Delay field indicates padding delay equal to 4 us times the value of the field. An example of the indication is in Table 1, Encoding of the MIC Preparation Padding Delay field.

A STA transmitting a PPDU that contains a BCC-encoded protected control frame shall ensure that for each target STA, the number of bits in the PSDU following a last bit (V_{LAST}) such as PN[47] (MSB bit of packet number (PN)), is at least CPAD, MAC, which may be termed M_{PAD, MAC}, and is based on the value of the MIC padding delay 1414 field or the MIC Computation Padding Delay indicated by the target STA.

The number of bits to pad can be determined using Equation (1). Equation (1): C_{PAD,MAC} or M_{PAD,MAC}=N_{DBPS}C_{PAD}, where N_{DBPS} is defined in Table 17-4 (Modulation-dependent parameters) for a non-HT PPDU, Table 19-7 (Frequently used parameters) for an HT PPDU, Table 21-6 (Frequently used parameters) for a VHT PPDU, and Table 27-16 (Frequently used parameters) for an HE PPDU and Table. If the protected control frame is carried in an HE MU PPDU or EHT MU PPDU, N_{DBPS} is replaced by N_{DBPS,u} of the target user. EHT MU PPDU s defined in Table 36-23 (Frequently used parameters).

C_{PAD} or M_{PAD} is defined as follows: For a non-HT PPDU, HT PPDU, and VHT PPDU, C_{PAD} Or M_{PAD} is: Indicated MIC Padding Delay (or MIC Padding Delay) in us divided by 4. Table 2 provides example numbers.

TABLE 2

| C_{PAD} or M_{PAD} | MIC Computation Padding Delay | |
|---|---|---|
| 0 | 0 | μs |
| 1 | 4 | μs |
| 2 | 8 | μs |
| 3 | 12 | μs |
| 4 | 16 | μs |
| 5 | 20 | μs |
| 6 | 24 | μs |
| 7 | 28 | μs |
| 8 | 32 | μs |

For an HE PPDU and EHT PPDU, C_{PAD} or M_{PAD} is indicated MIC Padding Delay in us divided by 16 and take ceiling function (or the values below can be used.) For example, 0 if MIC Padding Delay is 0 us; 1 if MIC Padding Delay is less than or equal to 16 us; and, 2 if MIC Padding Delay is less than or equal to 32 us

Define C_{Proc} (or V_{Proc}) as the duration of PPDU that is after the OFDM symbol containing the last coded bit of the LDPC codeword that encodes the PN[47] (or V_{LAST}) minus T_{PE,nominal} defined in 27.3.13 (Packet extension) for HE PPDU.

A STA transmitting a PPDU that contains a LDPC-encoded protected control frame shall ensure that for each target STA, C_{Proc} (or V_{Proc}) is greater than or equal to the MIC Computation Padding Delay (or MIC padding delay) indicated by the target STA.

A STA transmitting a PPDU that contains a BCC-encoded frame soliciting a protected control frame shall ensure that for each target STA, the number of bits in the PSDU following Pₗₐₛₜ (or Cₗₐₛₜ) is at least P_{PAD,MAC} (or M_{PAD,MAC}), which is based on the MIC Preparation Padding Delay or MIC padding delay indicated by the target STA, where Pₗₐₛₜ (or Cₗₐₛₜ) is: (1) The last bit of the FCS of the frame if the frame is not a protected control frame; (2) The last bit right before the Padding field of the frame if the frame is a Trigger frame.

P_{PAD,MAC}=N_{DBPS}P_{PAD}, where (P_{PAD,MAC} can be M_{PAD,MAC}). N_{DBPS} is defined in Table 17-4 (Modulation-dependent parameters) for a non-HT PPDU, Table 19-7 (Frequently used parameters) for an HT PPDU, Table 21-6 (Frequently used parameters) for a VHT PPDU, and Table 27-16 (Frequently used parameters) for an HE PPDU. If the protected control frame is carried in an HE MU PPDU or EHT MU PPDU, N_{DBPS} is replaced by N_{DBPS,u} of the target user in Equation (12-x2). N_{DBPS,u} for EHT MU PPDU s defined in Table 36-23 (Frequently used parameters).

P_{PAD} (or M_{PAD}) is defined as follows: For a non-HT PPDU, HT PPDU, and VHT PPDU, P_{PAD} is Indicated MIC Preparation Padding Delay in us divided by 4. Table 2 is an example.

TABLE 3

| P_{PAD}; MIC Padding Delay field value | MIC Preparation Padding Delay | |
|---|---|---|
| 0 | 0 | μs |
| 1 | 4 | μs |
| 2 | 8 | μs |
| 3 | 12 | μs |
| 4 | 16 | μs |
| 5 | 20 | μs |
| 6 | 24 | μs |
| 7 | 28 | μs |
| 8 | 32 | μs |

| | |
|---|---|
| 9-15 | Reserved |

For an HE PPDU, P_{PAD} is Indicated MIC Preparation Padding Delay in us divided by 16 and take ceiling function. For example, (1) 0 if MIC Preparation Padding Delay is 0 us; (2) 1 if MIC Preparation Padding Delay is less than or equal to 16 us; and, (3) 2 if MIC Preparation Padding Delay is less than or equal to 32 us.

Define P_{Proc} (C_{Proc}) or as the duration of PPDU that is after the OFDM symbol containing the last coded bit of the LDPC codeword that encodes the Pₗₐₛₜ of the frame soliciting a protected control frame minus T_{PE,nominal} defined in 27.3.13 (Packet extension) for HE PPDU. A STA transmitting a PPDU that contains a LDPC-encoded frame soliciting protected control frames shall ensure that for each target STA, P_{Proc} is greater than or equal to the MIC Preparation Padding Delay indicated by the target STA (see CIP Capabilities element 1400).

A STA shall not transmit a non-HT (duplicate) PPDU containing Data frame that solicits protected control frames from the target STA that indicates nonzero MIC Preparation Padding Delay. In an A-MPDU, A STA shall not use other MPDUs that is different from the protected control frame as the padding to satisfy the requirements of MIC Computation Padding Delay. Except the exception mentioned above, a STA may use any type of padding to satisfy the requirements such as using the Padding field in a Trigger frame, using the Padding field in a BAR frame, using the Padding field in a M-BA frame, using pre-EOF A-MPDU padding, using post-EOF A-MPDU padding, or aggregating other MPDUs in the A-MPDU.

The definition of new capabilities element for padding delay indication say Control integrity protocol (CIP) Capabilities element. The CIP Capability element contains fields that are used to advertise padding delay of CIP. The format of the CIP Capabilities element is shown in FIG. 14. The reserved 1416 field may be called a MIC computation padding delay. The Element ID, Length and Element ID Extension fields are defined in the communications standard. The Padding Delay field indicates the padding delay of CIP. The MIC Preparation Padding Delay field indicates the minimum padding duration of the PPDU soliciting protected control frame from the STA that sends the CIP Capability element as defined below. The MIC Preparation Padding Delay field indicates padding delay equal to 4 us times the value of the field. An example of the indication is in Table 9-xxx (Encoding of the MIC Preparation Padding Delay field). A STA transmitting a PPDU that contains a BCC-encoded protected control frame shall ensure that for each target STA, the number of bits in the PSDU following the PN[47] (MSB bit of packet number (PN)) is at least C_{PAD,MAC}, which is based on the MIC Computation Padding Delay indicated by the target STA (see above for definition of CIP Capabilities element). C_{PAD,MAC}=N_{DBPS}C_{PAD} (12-x1), where N_{DBPS} is defined in a Modulation-dependent parameters table in the communications standard) for a non-HT PPDU, (Frequently used parameters table) for an HT PPDU, (Frequently used parameters table) for a VHT PPDU, and (Frequently used parameters table) for an HE PPDU and. If the protected control frame is carried in an HE MU PPDU or EHT MU PPDU, N_{DBPS} is replaced by N_{DBPS,u} of the target user in the equation. N_{DBPS,u} for EHT MU PPDUs defined in (Frequently used parameters table).

C_{PAD} is defined as follows: For a non-HT PPDU, HT PPDU, and VHT PPDU, C_{PAD} is Indicated MIC Computation Padding Delay in us divided by 4. For example 0 if MIC Computation Padding Delay is 0 us; 1 if MIC Computation Padding Delay is 4 us; 2 if MIC Computation Padding Delay is 8 us; 3 if MIC Computation Padding Delay is 12 us; 4 if MIC Computation Padding Delay is 16 us; 5 if MIC Computation Padding Delay is 20 us; 6 if MIC Computation Padding Delay is 24 us; 7 if MIC Computation Padding Delay is 28 us; 8 if MIC Computation Padding Delay is 32 us.

For an HE PPDU and EHT PPDU, C_{PAD} is indicated MIC Computation Padding Delay in us divided by 16 and take ceiling function. For example, 0 if MIC Computation Padding Delay is 0 us; 1 if MIC Computation Padding Delay is less than or equal to 16 us; and, 2 if MIC Computation Padding Delay is less than or equal to 32 us. Define C_{Proc} as the duration of PPDU that is after the OFDM symbol containing the last coded bit of the LDPC codeword that encodes the PN[47] minus T_{PE,nominal} defined in (Packet extension section) for HE PPDU. A STA transmitting a PPDU that contains a LDPC-encoded protected control frame shall ensure that for each target STA, C_{Proc} is greater than or equal to the MIC Computation Padding Delay indicated by the target STA (see above). A STA transmitting a PPDU that contains a BCC-encoded frame soliciting a protected control frame shall ensure that for each target STA, the number of bits in the PSDU following Pₗₐₛₜ is at least P_{PAD,MAC}, which is based on the MIC Preparation Padding Delay indicated by the target STA (see above), where Pₗₐₛₜ is: The last bit of the FCS of the frame if the frame is not a protected control frame. The last bit right before the Padding field of the frame if the frame is a Trigger frame (General section) or BAR frame section of communication standard (overview).

P_{PAD,MAC}=N_{DBPS}P_{PAD}(12-x2) where N_{DBPS} is defined in (table for Modulation-dependent parameters) for a non-HT PPDU, (Table for Frequently used parameters) for an HT PPDU, (Table for Frequently used parameters) for a VHT PPDU, and (Table for Frequently used parameters) for an HE PPDU. If the protected control frame is carried in an HE MU PPDU or EHT MU PPDU, N_{DBPS} is replaced by N_{DBPS,u} of the target user in the equation above. N_{DBPS,u} for EHT MU PPDU s defined in (table for Frequently used parameters). P_{PAD} is defined as follows: For a non-HT PPDU, HT PPDU, and VHT PPDU, P_{PAD} is Indicated MIC Preparation Padding Delay in us divided by 4. For example, 0 if MIC Preparation Padding Delay is 0 us; 1 if MIC Preparation Padding Delay is 4 us; 2 if MIC Preparation Padding Delay is 8 us; 3 if MIC Preparation Padding Delay is 12 us; 4 if MIC Preparation Padding Delay is 16 us; 5 if MIC Preparation Padding Delay is 20 us; 6 if MIC Preparation Padding Delay is 24 us; 7 if MIC Preparation Padding Delay is 28 us; and, 8 if MIC Preparation Padding Delay is 32 us.

For an HE PPDU, P_{PAD} is indicated MIC Preparation Padding Delay in us divided by 16 and take ceiling function. For example, 0 if MIC Preparation Padding Delay is 0 us; 1 if MIC Preparation Padding Delay is less than or equal to 16 us; and, 2 if MIC Preparation Padding Delay is less than or equal to 32 us. Define P_{Proc} as the duration of PPDU that is after the OFDM symbol containing the last coded bit of the LDPC codeword that encodes the Pₗₐₛₜ of the frame soliciting a protected control frame minus T_{PE,nominal} defined in (section on Packet extension) for HE PPDU.

A STA transmitting a PPDU that contains a LDPC-encoded frame soliciting protected control frames shall ensure that for each target STA, P_{Proc} is greater than or equal to the MIC Preparation Padding Delay indicated by the target STA (section on CIP Capabilities element).

A STA shall not transmit a non-HT (duplicate) PPDU containing Data frame that solicits protected control frames from the target STA that indicates nonzero MIC Preparation Padding Delay. In an A-MPDU, A STA shall not use other MPDUs that is different from the protected control frame as the padding to satisfy the requirements of MIC Computation Padding Delay. Except the exception mentioned above, a STA may use any type of padding to satisfy the requirements such as using the Padding field in a Trigger frame, using the Padding field in a BAR frame, using the Padding field in a M-BA frame, using pre-EOF A-MPDU padding, using post-EOF A-MPDU padding, or aggregating other MPDUs in the A-MPDU.

The following are additional examples.

Example 1 is an apparatus for station (STA), the apparatus comprising: memory; and processing circuitry coupled to the memory, the processing circuitry configured to: decode, a Trigger frame, the Trigger frame comprising user information (info) fields, wherein a first contiguous user information (info) field of the user info fields comprises a first association identification (AID) 12 (AID12) field and a first intermediate (I) frame check sequence (FCS) (IFCS) field, the first AID12 field indicating a value that indicates the first user info field indicates a first portion of an IFCS, and the first IFCS field indicating bits 0 to 23 of the IFCS, and wherein a second contiguous user info field of the user info fields comprises a second AID12 field and a second IFCS field, the second AID12 field indicating the value that indicates the second user info field indicates a second portion of the IFCS, and the second IFCS field indicating bits 24 to 31 of the IFCS, and wherein the IFCS is a cyclic redundancy code (CRC); determine a CRC for a media access control (MAC) header of the trigger frame, and a frame body field of the trigger frame; and in response to the determined CRC being different than the CRC, determine the Trigger frame reception is not successful.

Example 2, the subject matter of Example 1 includes, wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.

Example 3, the subject matter of Examples 1 or 2 includes wherein the value that indicates the first user info field indicates a first portion of the PN and the value that indicates the second user info field indicates a second portion of the PN is 2009.

Example 4, the subject matter of Examples 1-3 includes wherein the user info fields are comprised in a trigger control Message Integrity Code (MIC) field.

Example 5, the subject matter of Examples 1-4 includes wherein the user info fields are comprised in a trigger control Message Integrity Code (MIC) field, and wherein a third user information (info) field, a fourth user info field, a fifth user info field, a sixth user info field, a seventh user info field, and an eighth user info field of the trigger control MIC field comprise a MIC value, and wherein each of the third user info field, the fourth user info field, the fifth user info field, the sixth user info field, the seventh user info field, and the eighth user info field comprise an association identification (AID) 12 (AID12) equal to a value indicating the third user info field, the fourth user info field, the fifth user info field, the sixth user info field, the seventh user info field, and the eighth user info field comprise the MIC value.

Example 6, the subject matter of Examples 1-5 includes wherein the value indicating the third user info field, the fourth user info field, the fifth user info field, the sixth user info field, the seventh user info field, and the eighth user info field comprise the MIC value is 2010.

Example 7, the subject matter of Examples 1-6 includes wherein the third user info field comprises bits 0 to 23 of the MIC value, the fourth user info field comprises bits 24 to 47 of the MIC value, and fifth user info field comprises bits 48 to 71 of the MIC value.

Example 8, the subject matter of Examples 1-7 includes wherein the sixth user info field comprises bits 72 to 95 of the MIC value, the seventh user info field comprises bits 96 to 119 of the MIC value, and eighth user info field comprises bits 120 to 127 of the MIC value.

Example 9, the subject matter of Examples 1-8 includes wherein the value that indicates the first user info field indicates a first portion of the IFCS and the value that indicates the second user info field indicates a second portion of the IFCS is 2011.

Example 10, the subject matter of Examples 1-9 includes wherein after the second contiguous user info field, the user info fields comprises another user info field for a STA that does not require a IFCS.

Example 11, the subject matter of Examples 1-10 includes wherein the CRC excludes the first contiguous user info field and the second contiguous user info field.

Example 12, the subject matter of Examples 1-11 includes wherein the AP is affiliated with an access point (AP) multi-link device (MLD).

Example 13, the subject matter of Examples 1-12 includes further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

Example 14 is a non-transitory computer-readable storage medium including instructions that, when processed by one or more processors, configure an apparatus of a station (STA) to perform operations comprising: decode, a Trigger frame, the Trigger frame comprising user information (info) fields, wherein a first contiguous user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second contiguous user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is a cyclic redundancy code (CRC);
determine a CRC for a media access control (MAC) header of the Trigger frame, and a frame body field of the Trigger frame; and in response to the determined CRC being different than the CRC, the Trigger frame reception is not successful.

Example 15, the subject matter of Example 14 includes a non-transitory computer-readable storage medium, wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.

Example 16, the subject matter of Examples 14 and 15 includes non-transitory computer-readable storage medium, wherein the value that indicates the first user info field indicates a first portion of the PN and the value that indicates the second user info field indicates a second portion of the PN is 2009, and wherein the user info fields are comprised in a trigger control Message Integrity Code (MIC) field.

Example 17, the subject matter of Examples 14-16 includes non-transitory computer-readable storage medium, wherein the user info fields are comprised in a trigger control Message Integrity Code (MIC) field, and wherein a third user information (info) field, a fourth user info field, a fifth user info field, a sixth user info field, a seventh user info field, and an eighth user info field of the trigger control MIC field comprise a MIC value, and wherein each of the third user info field, the fourth user info field, the fifth user info field, the sixth user info field, the seventh user info field, and the eighth user info field comprise an association identification (AID) 12 (AID12) equal to a value indicating the third user info field, the fourth user info field, the fifth user info field, the sixth user info field, the seventh user info field, and the eighth user info field comprise the MIC value.

Example 18, the subject matter of Examples 14-17 includes non-transitory computer-readable storage medium, wherein the value indicating the third user info field, the fourth user info field, the fifth user info field, the sixth user info field, the seventh user info field, and the eighth user info field comprise the MIC value is 2010.

Example 19 is an apparatus for an access point (AP), the apparatus comprising: memory; and processing circuitry coupled to the memory, the processing circuitry configured to: determine a cyclic redundancy code (CRC) for a media access control (MAC) header of a Trigger frame, and a frame body field of the Trigger frame; and encode, the Trigger frame, the Trigger frame comprising user information (info) fields, wherein a first contiguous user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second contiguous user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is the CRC.

Example 20, the Example 19 includes wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.

Example 21 is an apparatus comprising means to implement of any of Examples 1-20. Example 22 is a system to implement of any of Examples 1-20. Example 23 is a method to implement of any of Examples 1-20.

Example 24 is an apparatus for an access point (AP), the apparatus comprising: memory; and processing circuitry coupled to the memory, the processing circuitry configured to: decode, from a station (STA) a frame, the frame comprising a Control integrity protocol (CIP) capabilities element, the CIP capabilities element indicating a Message Integrity Code (MIC) padding delay field, the MIC Padding Delay field indicating a MIC Padding delay, the MIC Padding delay indicating a minimum padding duration for the STA; and encode, in accordance with Binary Convolutional Coding (BCC), a physical (PHY) protocol data unit (PPDU), the PPDU comprising a protected control frame, wherein a number of bits in the Physical Layer Service Data Unit (PSDU) following a last bit of a field is at least a number of data bits per Orthogonal Frequency-Division Multiplexing (OFDM) symbol (DBPS) of the PPDU times a number based on the minimum padding duration for the STA.

Example 25, the subject matter of Example 24, wherein a MIC Padding Delay field value of 0 indicates a MIC padding delay of 0 μs, a MIC Padding Delay field value of 1 indicates a MIC padding delay of 4 μs, a MIC Padding Delay field value of 2 indicates a MIC padding delay of 8 μs, a MIC Padding Delay field value of 3 indicates a MIC padding delay of 12 μs, a MIC Padding Delay field value of 4 indicates a MIC padding delay of 16 μs, a MIC Padding Delay field value of 5 indicates a MIC padding delay of 20 μs, a MIC Padding Delay field value of 6 indicates a MIC padding delay of 24 μs, a MIC Padding Delay field value of 7 indicates a MIC padding delay of 28 μs, and a MIC Padding Delay field value of 8 indicates a MIC padding delay of 32 μs.

Example 26, the subject matter of Examples 24 or 25, wherein if the PPDU is a non-high throughput (HT) PPDU, HT PPDU, or very-high throughput (VHT) PPDU, the number based on the minimum padding duration for the STA is 0 if the MIC padding delay for the STA is 0 μs, 1 if the MIC padding delay for the STA is 4 μs, 2 if the MIC padding delay for the STA is 8 μs, 3 if the MIC padding delay for the STA is 12 μs, 4 if the MIC padding delay for the STA is 16 μs, 5 if the MIC padding delay for the STA is 20 μs, 6 if the MIC padding delay for the STA is 24 μs, 7 if the MIC padding delay for the STA is 28 μs, and 8 if the MIC padding delay for the STA is 32 μs.

Example 27, the subject matter of Examples 24-26 wherein if the PPDU is an high-efficiency (HE) PPDU or an extremely-high throughput (EHT) PPDU, the number based on the minimum padding duration for the STA is 0 if the MIC padding delay for the STA is 0 μs, 1 if the MIC padding delay for the STA is less than or equal to 16 μs, and 2 if the MIC padding delay for the STA is less than or equal to 32 μs.

Example 28, the subject matter of Examples 24-27 wherein the protected control frame comprises a Trigger frame, a block acknowledgement request (BAR) frame, or a block acknowledgement (BA) frame, and wherein the field is a user information field if the protected control frame is a Trigger frame.

Example 29, the subject matter of Examples 24-28 wherein the protected control frame is soliciting a response protected control frame from the STA.

Example 30, the subject matter of Examples 24-29 wherein the protected control frame is a first protected control frame, the PPDU is a first PPDU, the PSDU is a first PSDU, and wherein the processing circuitry is further configured to: encode, in accordance with Low Density Parity Check (LDPC), a second physical (PHY) protocol data unit (PPDU), the second PPDU comprising a second protected control frame, wherein a duration of a second PSDU after a last Orthogonal Frequency-Division Multiplexing (OFDM) symbol comprising a last coded bit of a LDPC codeword including a last bit of a field minus a duration of a TPE, nominal for a high-efficiency (HE) PPDU or an extremely high throughput (EHT) PPDU is greater than or equal to the MIC padding delay for the STA.

Example 31, the subject matter of Examples 24-30 wherein the second PPDU is encoded for a plurality of STAs, the plurality of STAs comprising the STA, wherein each duration of each PSDU of a plurality of PSDUs for the plurality of STAs after a corresponding last OFDM symbol comprising a corresponding last coded bit of a corresponding LDPC codeword including a last bit of a field minus a corresponding duration of a TPE, nominal is greater than or equal to the MIC padding delay for a corresponding STA of the plurality of STAs.

Example 32, the subject matter of Examples 24-31 wherein TPE, nominal is equal to maxu (TPE,nominal,u), where TPE,nominal,u is a nominal TPE value for a user u as indicated by a communication standard and maxu is a maximum value for all u.

Example 33, the subject matter of Examples 24-32 wherein the PPDU is a non-high throughput (non-HT) PPDU, a non-HT duplicate PPDU, a HT PPDU, a very-HT (VHT) PPDU, a high-efficiency PPDU or an extremely high throughput (EHT) PPDU.

Example 34, the subject matter of Examples 24-33 wherein the PPDU is a HE multi-user (MU) PPDU, the PPDU is encoded for a plurality of users, the plurality of users comprising the user, and wherein the number of bits in the PSDU following a last bit of the field is based on a target user of the plurality of users.

Example 35, the subject matter of Examples 24-34 wherein the protected control frame is a first protected control frame, the PPDU is a first PPDU, and wherein the processing circuitry is further configured to: encode, in accordance with BCC, a second PPDU, the second PPDU comprising a last frame that solicits a protected control frame, wherein a number of bits in the Physical Layer Service Data Unit (PSDU) following a last bit of a field of the frame is at least a number of data bits per Orthogonal Frequency-Division Multiplexing (OFDM) symbol of the PPDU times a number based on the minimum padding duration for the STA.

Example 36, the subject matter of Examples 24-35 wherein the protected control frame is a first protected control frame, the PPDU is a first PPDU, the PSDU is a first PSDU, and wherein the processing circuitry is further configured to: encode, in accordance with Low Density Parity Check (LDPC), a second physical (PHY) protocol data unit (PPDU), the second PPDU comprising a last frame that solicits a second protected control frame, wherein a duration of a second PSDU after a last Orthogonal Frequency-Division Multiplexing (OFDM) symbol comprising a last coded bit of a LDPC codeword including a last bit of a field of the frame is greater than or equal to the MIC padding delay for the STA.

Example 37, the subject matter of Examples 24-36 wherein the AP is affiliated with an access point (AP) multi-link device (MLD).

Example 38, the subject matter of Examples 24-37 further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

Example 39 is non-transitory computer-readable storage medium including instructions that, when processed by one or more processors, configure an apparatus of an access point (AP) to perform operations comprising: decode, from a station (STA) a frame, the frame comprising a Control integrity protocol (CIP) capabilities element, the CIP capabilities element indicating a Message Integrity Code (MIC) padding delay field, the MIC Padding Delay field indicating a MIC Padding delay, the MIC Padding delay indicating a minimum padding duration for the STA; and encode, in accordance with Binary Convolutional Coding (BCC), a physical (PHY) protocol data unit (PPDU), the PPDU comprising a protected control frame, wherein a number of bits in the Physical Layer Service Data Unit (PSDU) following a last bit of a field is at least a number of data bits per Orthogonal Frequency-Division Multiplexing (OFDM) symbol (DBPS) of the PPDU times a number based on the minimum padding duration for the STA.

Example 40, the subject matter of Example 39 incluces non-transitory computer-readable storage medium of claim 16, wherein a MIC Padding Delay field value of 0 indicates a MIC padding delay of 0 μs, a MIC Padding Delay field value of 1 indicates a MIC padding delay of 4 μs, a MIC Padding Delay field value of 2 indicates a MIC padding delay of 8 μs, a MIC Padding Delay field value of 3 indicates a MIC padding delay of 12 μs, a MIC Padding Delay field value of 4 indicates a MIC padding delay of 16 μs, a MIC Padding Delay field value of 5 indicates a MIC padding delay of 20 μs, a MIC Padding Delay field value of 6 indicates a MIC padding delay of 24 μs, a MIC Padding Delay field value of 7 indicates a MIC padding delay of 28 μs, and a MIC Padding Delay field value of 8 indicates a MIC padding delay of 32 μs.

Example 41 is an apparatus for a station (STA), the apparatus comprising: memory; and processing circuitry coupled to the memory, the processing circuitry configured to: encode, for an access point (AP) a frame, the frame comprising a Control integrity protocol (CIP) capabilities element, the CIP capabilities element indicating a Message Integrity Code (MIC) padding delay field, the MIC Padding Delay field indicating a MIC Padding delay, the MIC Padding delay indicating a minimum padding duration for the STA; and decode, from the AP, in accordance with Binary Convolutional Coding (BCC), a physical (PHY) protocol data unit (PPDU), the PPDU comprising a protected control frame, wherein a number of bits in the Physical Layer Service Data Unit (PSDU) following a last bit of a field is at least a number of data bits per Orthogonal Frequency-Division Multiplexing (OFDM) symbol (DBPS) of the PPDU times a number based on the minimum padding duration for the STA.

Example 42, the subject matter of Example 41 includes wherein a MIC Padding Delay field value of 0 indicates a MIC padding delay of 0 μs, a MIC Padding Delay field value of 1 indicates a MIC padding delay of 4 μs, a MIC Padding Delay field value of 2 indicates a MIC padding delay of 8 μs, a MIC Padding Delay field value of 3 indicates a MIC padding delay of 12 μs, a MIC Padding Delay field value of 4 indicates a MIC padding delay of 16 μs, a MIC Padding Delay field value of 5 indicates a MIC padding delay of 20 μs, a MIC Padding Delay field value of 6 indicates a MIC padding delay of 24 μs, a MIC Padding Delay field value of 7 indicates a MIC padding delay of 28 μs, and a MIC Padding Delay field value of 8 indicates a MIC padding delay of 32 μs.

Example 43, the subject matter of Examples 41 or 42 includes wherein if the PPDU is a non-high throughput (HT) PPDU, HT PPDU, or very-high throughput (VHT) PPDU, the number based on the minimum padding duration for the STA is 0 if the MIC padding delay for the STA is 0 μs, 1 if the MIC padding delay for the STA is 4 μs, 2 if the MIC padding delay for the STA is 8 μs, 3 if the MIC padding delay for the STA is 12 μs, 4 if the MIC padding delay for the STA is 16 μs, 5 if the MIC padding delay for the STA is 20 μs, 6 if the MIC padding delay for the STA is 24 μs, 7 if the MIC padding delay for the STA is 28 μs, and 8 if the MIC padding delay for the STA is 32 μs.

Example 44 is an apparatus comprising means to implement of any of Examples 24-43. Example 45 is a system to implement of any of Examples 24-43. Example 46 is a method to implement of any of Examples 24-43.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for station (STA), the apparatus comprising: memory; and processing circuitry coupled to the memory, the processing circuitry configured to:
decode, a trigger frame, the trigger frame comprising user information (info) fields, wherein a first user information (info) field of the user info fields comprises a first association identification (AID) 12 (AID12) field and a first intermediate (I) frame check sequence (FCS) (IFCS) field, the first AID12 field indicating a value that indicates the first user info field indicates a first portion of an IFCS, and the first IFCS field indicating bits 0 to 23 of the IFCS, and wherein a second user info field of the user info fields comprises a second AID12 field and a second IFCS field, the second AID12 field indicating the value that indicates the second user info field indicates a second portion of the IFCS, and the second IFCS field indicating bits 24 to 31 of the IFCS, and wherein the IFCS is a cyclic redundancy code (CRC);
determine a CRC for a media access control (MAC) header of the trigger frame, and a frame body field of the trigger frame; and
in response to the determined CRC being different than the CRC, determine a reception of the trigger frame is not successful.

2. The apparatus of claim 1, wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.

3. The apparatus of claim 2, wherein the value that indicates the first user info field indicates a first portion of the PN and the value that indicates the second user info field indicates a second portion of the PN is 2009.

4. The apparatus of claim 2, wherein the user info fields are comprised in a trigger control Message Integrity Code (MIC) field.

5. The apparatus of claim 1, wherein the user info fields are comprised in a trigger control Message Integrity Code (MIC) field, and wherein a third user information (info) field, a fourth user info field, a fifth user info field, a sixth user info field, a seventh user info field, and an eighth user info field of the trigger control MIC field comprise a MIC value, and wherein each of the third user info field, the fourth user info field, the fifth user info field, the sixth user info field, the seventh user info field, and the eighth user info field comprise an association identification (AID) 12 (AID12) equal to a value indicating the third user info field, the fourth user info field, the fifth user info field, the sixth user info field, the seventh user info field, and the eighth user info field comprise the MIC value.

6. The apparatus of claim 5, wherein the value indicating the third user info field, the fourth user info field, the fifth user info field, the sixth user info field, the seventh user info field, and the eighth user info field comprise the MIC value is 2010.

7. The apparatus of claim 5, wherein the third user info field comprises bits 0 to 23 of the MIC value, the fourth user info field comprises bits 24 to 47 of the MIC value, and fifth user info field comprises bits 48 to 71 of the MIC value.

8. The apparatus of claim 7, wherein the sixth user info field comprises bits 72 to 95 of the MIC value, the seventh user info field comprises bits 96 to 119 of the MIC value, and eighth user info field comprises bits 120 to 127 of the MIC value.

9. The apparatus of claim 1, wherein the value that indicates the first user info field indicates a first portion of the IFCS and the value that indicates the second user info field indicates a second portion of the IFCS is 2011.

10. The apparatus of claim 1, wherein after the second user info field, the user info fields comprises another user info field for a STA that does not require a IFCS.

11. The apparatus of claim 1, wherein the CRC excludes the first user info field and the second user info field, and wherein the first user info field and the second user info field are contiguous.

12. The apparatus of claim 1, wherein the STA is affiliated with an access point (AP) multi-link device (MLD).

13. The apparatus of claim 1, further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

14. A non-transitory computer-readable storage medium including instructions that, when processed by one or more processors, configure an apparatus of a station (STA) to perform operations comprising:
decode, a trigger frame, the trigger frame comprising user information (info) fields, wherein a first user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is a cyclic redundancy code (CRC);
determine a CRC for a media access control (MAC) header of the Trigger frame, and a frame body field of the Trigger frame; and
in response to the determined CRC being different than the CRC, determine a reception of the trigger frame was not successful.

15. The non-transitory computer-readable storage medium of claim 14, wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.

16. The non-transitory computer-readable storage medium of claim 15, wherein the value that indicates the first user info field indicates a first portion of the PN and the value that indicates the second user info field indicates a second portion of the PN is 2009, and wherein the user info fields are comprised in a trigger control Message Integrity Code (MIC) field.

17. The non-transitory computer-readable storage medium of claim 14, wherein the user info fields are comprised in a trigger control Message Integrity Code (MIC) field, and wherein a third user information (info) field, a fourth user info field, a fifth user info field, a sixth user info field, a seventh user info field, and an eighth user info field of the trigger control MIC field comprise a MIC value, and wherein each of the third user info field, the fourth user info field, the fifth user info field, the sixth user info field, the seventh user info field, and the eighth user info field comprise an association identification (AID) 12 (AID12) equal to a value indicating the third user info field, the fourth user info field, the fifth user info field, the sixth user info field, the seventh user info field, and the eighth user info field comprise the MIC value.

18. The non-transitory computer-readable storage medium of claim 17, wherein the value indicating the third user info field, the fourth user info field, the fifth user info field, the sixth user info field, the seventh user info field, and the eighth user info field comprise the MIC value is 2010, and wherein the first user info field and the second user info field are contiguous.

19. An apparatus for an access point (AP), the apparatus comprising: memory; and processing circuitry coupled to the memory, the processing circuitry configured to:
determine a cyclic redundancy code (CRC) for a media access control (MAC) header of a Trigger frame, and a frame body field of the Trigger frame; and
encode, the Trigger frame, the Trigger frame comprising user information (info) fields, wherein a first user information (info) field of the user info fields comprises a first association identification (AID) 12 (AID12) field and a first intermediate (i) frame check sequence (FCS) (iFCS) field, the first AID12 field indicating a value that indicates the first user info field indicates a first portion of an iFCS, and the first iFCS field indicating bits 0 to 23 of the iFCS, and wherein a second user info field of the user info fields comprises a second AID12 field and a second iFCS field, the second AID12 field indicating the value that indicates the second user info field indicates a second portion of the iFCS, and the second iFCS field indicating bits 24 to 31 of the iFCS, and wherein the iFCS is the CRC.

20. The apparatus of claim 19, wherein a first user information (info) field of the user info fields comprises a first association identification (AID) 12 (AID12) field, a zero packet number (PN0) field, a first PN (PN1) field, and a second PN (PN2) field, the first AID12 field indicating a value that indicates the first user info field indicates a first portion of a PN, the PN0 field indicating a first byte of the PN, the PN1 field indicating a second byte of the PN, and the PN2 indicating a third byte of the PN, and comprising a second user info field of the user info fields, the second user info field comprising a second AID12 field, a third packet number (PN3) field, a fourth PN (PN4) field, and a fifth PN (PN5) field, the second AID12 field indicating the value that indicates the second user info field indicates a second portion of the PN, the PN3 field indicating a fourth byte of the PN, the PN4 field indicating a fifth byte of the PN, and the PN5 indicating a sixth byte of the PN.
